(19) United States
(12) Patent Application Publication
(10) Pub. No.: US 2015/0281517 A1
(43) Pub. Date: Oct. 1, 2015

(54) IMAGE SCANNING APPARATUS

(71) Applicant: BROTHER KOGYO KABUSHIKI KAISHA, Nagoya (JP)

(72) Inventors: Yuji HORI, Hashima-gun (JP); Taiki YAMANO, Nagoya (JP); Takahiro IKENO, Seto-shi (JP)

(21) Appl. No.: 14/669,657

(22) Filed: Mar. 26, 2015

(30) Foreign Application Priority Data
Mar. 31, 2014 (JP) 2014-074564

(51) Int. Cl. H04N 1/407

(52) U.S. Cl. CPC H04N 1/4072

(57) ABSTRACT

A controller is configured to set a reference gradation value when a gray reference member is illuminated. When the number of pixels, of which the gradation values is equal to or greater than the reference gradation value, is a target number of pixels, both are stored in association with each other. A correction target number which is a minimum target number of pixels from among a plurality of target numbers of pixels respectively providing differences, which is less than a predetermined value, between the reference gradation values stored in association with an M-th target number and an (M+1)-th target number. The controller further determines an anomaly pixel number which is the number of anomaly pixels having gradation values which are equal to or greater than a base gradation value. The gradation values of the determined number of anomaly pixels are corrected.

### CROSS-REFERENCE TO RELATED APPLICATION

This application claims priority under 35 U.S.C. §119 from Japanese Patent Application No. 2014-074564 filed on Mar. 31, 2014. The entire subject matter of the application is incorporated herein by reference.

### BACKGROUND

1. Technical Field

The present disclosures relate to an image scanning apparatus using a gray reference member of which a reflection coefficient is lower than that of a white reflection member.

2. Related Art

Generally, an image scanning apparatus employs a white reference member as a light distribution reference member to be used for a shading correction. When scanning is executed, an image of an original sheet passing over the white reference member is scanned. When the white reference member is used, however, there may occur a show-through phenomenon which is a phenomenon that a change in thickness of color on a back surface of the original sheet affects scanning of an image formed on a front surface of the original sheet. In order to reduce such a show-through phenomenon, image scanning apparatuses employing the gray reference member, which has a smaller reflection coefficient than the white reference member, have been suggested recently.

An example of such an image scanning apparatus employs a non-white reference member which is provided as a guide for the original sheet in a sheet conveying device. In such an image scanning apparatus, the shading correction is performed, based on the reflection coefficient of the non-white reference member, so that a reflection density value obtained by scanning the non-white reference member has substantially the same quantity as a reflection density value obtained by scanning the white reference member. When an image on the original sheet, which is conveyed by the conveying device, is scanned, the shading correction is applied based on the reflection density value compensated as above.

When dust or blot is adhered on a reflection surface of the reference member, density values of pixels obtained by scanning a portion of the reflection surface on which the dust or blot is adhered may be largely different with respect to the density values of neighboring pixels. When the light quantity of the light source is adjusted so that the reflection density value obtained by scanning the gray reference member has a predetermined density value, it is necessary to determine whether the reflection density values, or gradation values obtained by scanning the gray reference member includes values which vary relatively largely with respect to the density values (or gradation values) of the neighboring pixels.

When density values for one line, namely gradation values for one line of pixels are obtained by scanning the gray reference member, whether the gradation values fluctuates relatively largely due to the dust/blot may be determined. However, execution of such a determination for all the pixels may result in elongation of scanning period.

In consideration of the above, aspects of the disclosures provide an improved image scanning apparatus capable of obtaining accurate gradation values when the gray reference member is scanned, without elongating the time period for scanning.

According to aspects of the disclosures, there is provided an image scanning apparatus which is provided with a gray reference member arranged in a conveying path in which an original sheet is to be conveyed, the gray reference member having a reflection coefficient smaller than that of a white color, a scanning unit configured to scan an image on the original sheet on a line basis, the scanning unit including a light source configured to illuminate the original sheet when passing the gray reference member and a plurality of photoelectric conversion elements aligned in a scanning direction which is a transverse direction of the conveying path, a signal conversion unit configured to convert analog signals from the plurality of photoelectric conversion elements to digital signals, respectively, a storage and a controller. The controller is configured to set first to N-th target numbers of pixels each representing the number of a plurality of pixels, N being more than two, changeably set a reference gradation value which represents a value of a white signal output by the signal conversion unit for each pixel when the light source illuminates the gray reference member, between a highest gradation value and a smaller gradation value which is smaller than the highest gradation value, store, in the storage, a specific reference gradation value in association with the target number of pixels when the number of pixels having gradation values equal to or greater than the specific reference gradation value is a specific target number of pixels, determine a correction target number which is a minimum target number of pixels from among a plurality of target numbers of pixels respectively providing differences, which is less than a predetermined value, between the reference gradation value stored in association with an M-th target number among the first to N-th target numbers and the reference gradation stored in association with an (M+1)-th target number, determine an anomaly pixel number which is the number of anomaly pixels having gradation values which are equal to or greater than a reference gradation value, the reference gradation value being determined based on the reference gradation value stored in the storage in association with the correction target number of pixels from among the gradation values of the with signal output by the signal conversion unit for respective pixels when the light source illuminates the gray reference member, and correct the gradation values of the anomaly pixels, the number of the anomaly pixels of which gradation values are to be corrected being the anomaly pixel number.

It is noted that the scanning unit may be configured to scan an image on only one surface of the original sheet or images on both sides of the original sheet. In the latter case, two scanning units may be arranged along the sheet conveying path to face the original sheet from opposite directions.

According to aspects of the disclosures, as far as the base gradation value is determined based on the reference gradation value which is stored in association with the target number of pixels, a method of determining the reference gradation value is not limited to a specific one. For example, the base gradation value may determined to have the same value of the reference gradation value which is stored in association with the target number of pixels, or a value obtained by adding a predetermined value to the reference gradation value.

According to aspects of the disclosures, correction of the gradation values corresponding to the anomaly pixels due to dust or the like can be made in various ways. For example, the gradation value of an anomaly pixel may be replaced with the gradation value of the neighboring pixel(s), or replaced with an average of the gradation values of the white signal output by the signal conversion unit for respective pixels of one line.

### BRIEF DESCRIPTION OF THE ACCOMPANYING DRAWINGS

FIG. 1 is a cross-sectional side view schematically showing main components of an image scanning apparatus according to an illustrative embodiment of the disclosures.

FIG. 2 schematically shows a scanning unit of the image scanning apparatus according to the illustrative embodiment of the disclosures.

FIG. 3 schematically shows a configuration of a light receiving unit of the scanning unit according to the illustrative embodiment of the disclosures.

FIG. 4 is a block diagram showing an electrical configuration of the image scanning apparatus according to the illustrative embodiment of the disclosures.

FIG. 5 is a flowchart illustrating a scanning main process according to the illustrative embodiment of the disclosures.

FIG. 6 is a flowchart illustrating an anomaly pixel counting process, which is a sub process according to the illustrative embodiment of the disclosures.

FIG. 7 is a flowchart illustrating a scanning light quantity adjusting process, which is a sub process according to the illustrative embodiment of the disclosures.

FIG. 8 is a flowchart illustrating a shading light quantity adjusting process, which is a process according to the illustrative embodiment of the disclosures.

FIG. 9 is a flowchart illustrating an anomaly pixel data correction process, which is a sub process according to the illustrative embodiment of the disclosures.

FIG. 10 is a flowchart illustrating a shading correction data calculation process, which is a sub process according to the illustrative embodiment of the disclosures.

FIG. 11 is a graph showing gradation values of gray-referenced white data, gray-referenced gray data, and gray-referenced black data.

### DETAILED DESCRIPTION OF THE ILLUSTRATIVE EMBODIMENTS

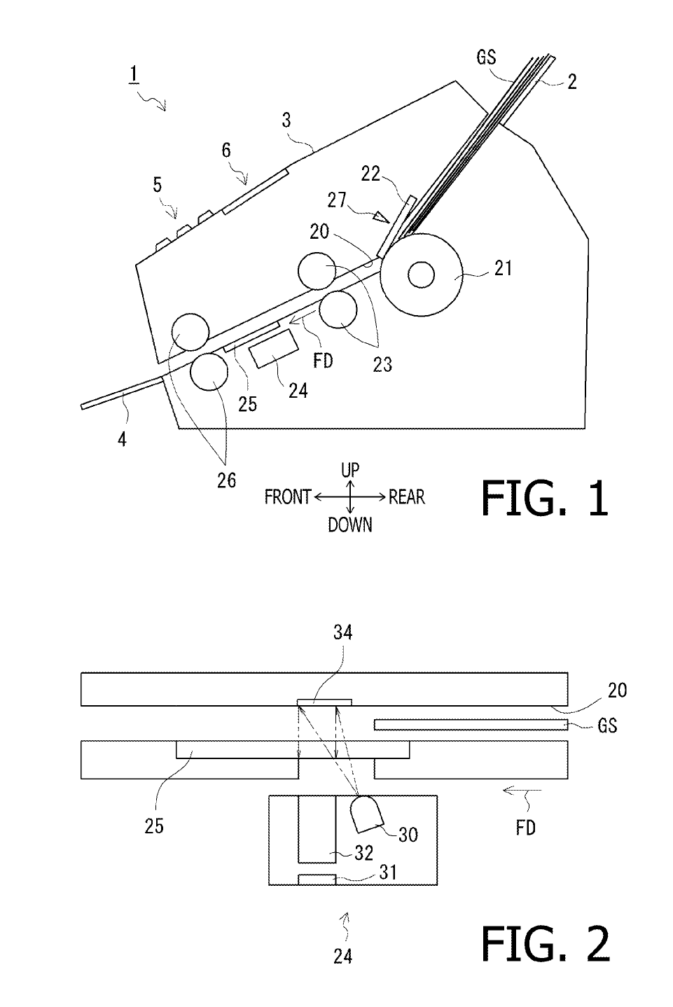

Hereinafter, referring to the accompanying drawings, an image scanning apparatus 1 according to an illustrative embodiment of the disclosures will be described. In the following description, when directions are indicated, directions depicted in FIG. 1 will be referred to.

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storages, hard disk drives, floppy drives, permanent storages, and the like.

As shown in FIG. 1, the image scanning apparatus 1 has a sheet feeding tray 2, a main body 3, a discharged sheet tray 4. Further, an operation unit 5, a display unit 6 are arranged on an upper surface of the main body 3. The operation unit 5 includes a power switch, and various setting buttons, and is configured to acquire an operational instructions by a user. For example, the operation unit 5 may include a selection button to select a color mode using three colors or a monochrome mode using a single color, a resolution setting operation button, and the like. The display unit 6 includes an LCD (liquid crystal display) and displays an operational status of the image scanning apparatus 1.

A conveying path 20 is defined inside the main body 3. The original sheets GS placed on the sheet feeding tray 2 are conveyed in a conveying direction FD, along the conveying path 20, and is discharged on a discharged sheet tray 4. A feeding roller 21, a separation pad 22, a pair of upstream conveying rollers 23, a scanning unit 24, a platen glass 25 and a pair of downstream conveying rollers 26 are arranged along the conveying path 20 as shown in FIG. 1.

The feeding roller 21, in association with the separation pad 22, feeds the plurality of original sheets GS placed on the sheet feeding tray 2 one by one. The upstream conveying rollers 23 and the downstream conveying rollers 26 are driven by a conveying motor MT (see FIG. 4). The platen glass 25 is a transparent member and arranged along and below the conveying path 20. The conveying rollers 23 and 26 convey the original sheet GS fed from the feeding roller 21 to pass over the platen glass 25.

According to the illustrative embodiment, the original sheets GS are placed on the sheet feeding tray 2 such that a scan surface (i.e., a surface subject to scan) of each original sheet GS face the placement surface of the sheet feeding tray 2. The scanning unit 24 is arranged below the conveying path 20, and scans an image on the scan surface of the original sheet GS as it passes over the platen glass 25. An original sheet sensor 27 is arranged on the sheet feeding tray 2, which sensor 25 is turned ON when one or more original sheets GS are placed on the sheet feeding tray 2, while the sensor 25 is turned OFF when there is no sheet GS on the sheet feeding tray 2.

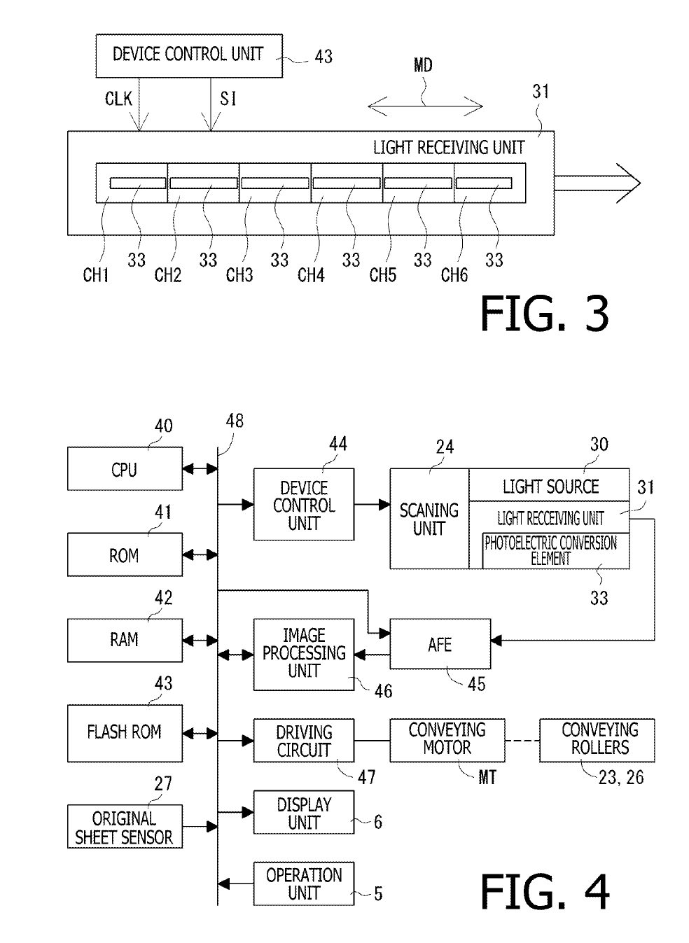

A configuration of the scanning unit 24 will be described in detail, referring to FIGS. 2 and 3. In FIG. 2, the scanning unit 24 has a light source 30, a light receiving unit 31, and an optical element 32. The light source 30 includes red, green and blue LEDs (light emitting diodes) emitting red, green and blue light, respectively. The light emitted from the light source 30 is reflected by the scan surface of the original sheet GS at a portion above the platen glass 25. Then, the reflected light is directed to the light receiving element 31 through the optical element 32. When the color mode is selected, one line of the image on the original sheet GS is scanned by sequentially turning on the red, green and blue LEDs. When the monochrome mode is selected, a specific one of the three-color LEDs (e.g., the red LED) is turned on to obtain one line of image on the original sheet GS.

A gray reference plate 34 is arranged at a position opposite to the scanning unit 24 with respect to the conveying path 20 and facing the scanning unit 24. The gray reference plate 34 has a lower reflection coefficient than a background color (i.e., white) of the original sheet GS. When there is not an original sheet GS in the conveying path 20, the light emitted by the light source 30 is reflected by the gray reference plate 34, and the reflected light is received, through the optical element 32, by the light receiving unit 31. According to the illustrative embodiment, the optical element 32 includes a rod lens extending in a direction of a main scanning direction MD (see FIG. 3).

In FIG. 3, the light receiving unit 31 has a plurality of sensor IC (integrated circuit) chips linearly arranged in the main scanning direction MD. Each IC chip includes a plurality of photoelectric conversion elements 33 aligned in the main scanning direction MD, and further includes a shift register and a built-in amplifier. The plurality of sensor IC chips are divided into six channels CH1-CH6. Each channel includes one or two sensor IC chips. Since a configuration of such a sensor IC chip (i.e., one having a plurality of IC chips) is well-known, detailed description thereof will be omitted for brevity.

An electrical configuration of the image scanning apparatus 1 will be described, referring to FIG. 4. As shown in FIG. 4, the scanning apparatus 1 includes a CPU (central processing unit) 40, a ROM (read only memory) 41, a RAM (random access memory) 42, a flash PROM (a flash programmable ROM) 43, a device control unit 44, an analog front end IC (hereinafter, abbreviated as AFE) 45, an image processing unit 46 and a driving circuit 47. These components are connected to the operation unit 5, the display unit 6 and the original sheet sensor 27 through a bus 48.

The ROM 41 stores programs causing the image scanning apparatus 1 to execute a maintenance main process, a scanning main process, and sub processes called in the main processes. The CPU 40 controls respective components/units in accordance with the programs retrieved from the ROM 41. The flash PROM 43 is a rewritable non-volatile memory and stores various pieces of data which are generated during processing of the CPU 40 (e.g., current values and illumination periods). The RAM 42 temporarily stores calculation results and the like generated during the controlling processes executed by the CPU 40.

The device control unit 44 is connected to the scanning unit 24, and transmits signals to control power on/off of the light source 30 and a signal to control a value of an electrical current flowing through the light source 30 to the scanning unit 24 under control of the CPU 40. Further, the device control unit 44 transmits a clock signal CLK and a serial in signal SI to the light receiving unit 31 (see FIG. 3) in order to sequentially drive the plurality of photoelectric conversion elements 33 of each of the IC chips of the light receiving unit 31 in accordance with instructions from the CPU 40. When the scanning unit 24 receives the illumination control signal from the device control unit 44, the scanning unit 24 powers on the light source 30 and transmits the analog signal corresponding to the light quantity of the light the light receiving unit 31 has received to the AFE 45.

The AFE 45 is connected to the scanning unit 24, and converts the analog signal transmitted from the scanning unit 24 to a digital signal in accordance with instructions from the CPU 40. The AFE 45 has a predetermined input range and resolution power. For example, when the resolution power is 10 bits, 1024 gradation steps (i.e., 0-1023) can be achieved. In such a case, the AFE 45 is capable of converting the analog signal transmitted from the scanning unit 24 into 10-bit digital signal (i.e., gradation data) represented in 1024 gradation steps. The gradation data converted and generated by the AFE 45 is transmitted to the image processing unit 46. The image processing unit 46 includes an ASIC (application-specific integrated circuit) particularly designed for an image processing, and applies various image processing operations to the gradation data. The image processing operations may include a shading correction, various types of other corrections (e.g., y correction), a resolution conversion process and the like. The image processing unit 46 applies such image processing operations to the gradation data, and generates bit-rate converted image data, for example, eight-bit image data. The thus generated image data is transmitted through the bus 48 to the RAM 42 and stored therein.

The driving circuit 47 is connected to the conveying motor MT, and drives the conveying motor MT in accordance with driving instructions transmitted from the CPU 40. The driving circuit 47 rotates the conveying motor MT in accordance with a rotation amount and a rotation direction instructed by the driving instructions. When the conveying motor MT rotates by a predetermined amount, the conveying rollers 23 and 26 rotate by predetermined angles, thereby the original sheet GS being conveyed along the conveying path 20 by a predetermined distance.

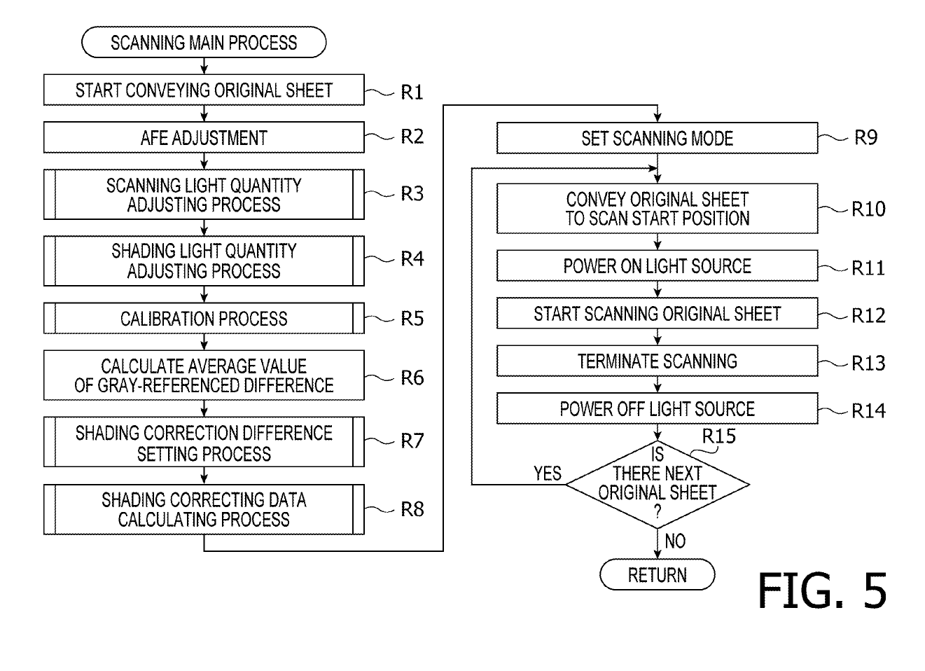

Next, a scanning main process of the image scanning apparatus 1 will be described with reference to the drawings. The scanning main process shown in FIG. 5 is started when the user operates a scanning start button of the operation unit 5. Steps R1-R15 of the scanning main process, and steps of each sub process are executed by the CPU 40. A data processing the CPU 40 executes for one line is the process for each of the pixels of three colors in the color mode, or the process for each of the pixels of one specific color in the monochrome mode.

When the user placed the original sheets GS for scanning and operate the scanning start button of the operation unit 5, the original sheet sensor 27 detects the original sheet GS. In accordance with a detection signal from the original sheet sensor 27, the CPU 40 starts conveying the original sheets GS (R1).

In R2, various adjustment processes for the AFE 45 are executed. The AFE 45 outputs the gradation data within a range from the maximum gradation data to the minimum gradation data. When the gradation data is the 10-bit data, the maximum gradation data is “1023” and the minimum gradation data is “0”. A maximum input voltage and a minimum input voltage to be input to the AFE 45 in order to output the maximum gradation data and the minimum gradation data, respectively, are preliminarily determined based on a configuration of an A/D convertor built in the AFE 45. It is also noted that a maximum output voltage and a minimum output voltage of the analog signal output by the photoelectric conversion element 33 of the light receiving unit 31 are preliminarily determined based on a configuration of the photoelectric conversion elements 33. Thus, as one of adjustment operations of the AFE 45, adjustment of an off-set value and an amplifier gain is executed.

In R3, the number of anomaly pixels is calculated. That is, in accordance of a series of processes including a process of counting the number of pixels of which the gradation data output by the AFE 45 when the light source 30 illuminates the gray reference plate 34 is equal to or greater than the overflow determination value which is sequentially reduced from its maximum gradation value, the number of anomaly pixels is counted. The process (i.e., an anomaly pixel counting process) will be described in detail later.

In R4, the scanning light quantity is adjusted. The brightest gray gradation data from among data output by the AFE 45, or the maximum value Dggmx of the gray-referenced gray data Dgg when the light source 30 illuminates the gray reference plate 34 when the image scanning apparatus is about to shipped is preliminarily stored in the flash PROM 43. Thus, in R4, the electrical current value VCrd for scanning and scanning illuminating period DLrd are calculated so that the AFE 45 can output the gradation data having the same gradation value as the maximum value Dggmax. The details of the scanning light quantity

In R5, the shading light quantity is adjusted. The shading light quantity is a process of setting the shading light quantity by calculating the electrical current value VDsh and the illuminating period LDsh when the light source 30 illuminated the gray reference plate 34. An adjustment process of the shading light quantity is described later in detail.

In R6, an average value of the gray reference data is calculated. That is, the white gradation data output by the AFE 45 in accordance with the analog signal transmitted from the light receiving unit 31 under a state where the light source 30 is powered on in accordance with the electrical current value VCsh and the illuminating period DLsh set in M8 (i.e., the gray-referenced white data) Dgw is repeatedly obtained for each of the pixels of one line by a predetermined times and stored in the RAM 42. Then, an average value Agw of the repeatedly obtained gray-referenced white data Dgw is calculated for each of the pixels of one line and stored in the RAM 42. It is noted that the average value Agw is a value averaging the gradation values of the gray-referenced white data Dgw for each pixel.

FIG. 11 shows change of the gradation values of the gray-referenced white data Dgw and the gray-referenced black data Dgb for one line. It is noted that, in FIG. 11, a vertical axis represents the gradation value of the gradation data output by the AFE 45, while a horizontal axis represents a position of each of the pixels of one line, from a top thereof to the end thereof In FIG. 13, the gray-referenced gray data Dgg is also indicated.

In R7, data correction for anomaly pixels is executed. In this process, for each of the anomaly pixels, the average value Agw of the gray-referenced white data Dg2 of the anomaly pixels is replaced with a corrected average value. The anomaly pixel data correction process will be described later in detail.

In R8, the shading correction data is calculated. By a series of processes including a process of calculating a shading target value Atw, the shading data is calculated. Details of calculation of the shading correction data will be described later.

In R9, the scanning mode is set. As settings of the scanning mode, a selection between the color mode and the monochrome mode, setting of the resolution and the like is executed. After setting of the scanning mode is executed, the original sheet GS is conveyed to the scanning start position (R10). That is, the original sheet GS is conveyed with use of the feeding roller 21 and the upstream conveying rollers 23 until a leading end of the original sheet GS reaches a predetermined position on an upstream side of the scanning unit 24. Thereafter, the light source 30 is driven in accordance with the current value VCrd and the illuminating period DLrd set in R4, and the original sheet GS is illuminated by the light emitted by the light source 30 (R11).

In R12, scanning of the original sheet GS is started. When the image of the original sheet GS is scanned, the AFE 45 generates the gradation data in accordance with the analog signal transmitted from the light receiving unit 31, and transmits the generated gradation data to the image processing unit 46. The image processing unit 46 receives the shading correction data which is calculated in R8 from the CPU 40. Then, the image processing unit 46 corrects the gradation data with use of the shading correction data and generates image data. The thus generated image data is stored in the RAM 42.

When a trailing end of the original sheet GS has passed the scanning unit 24, the scanning of the original sheet GS is completed (R13). When the scanning is completed, the light source 30 is powered off (R14). Based on the detection signal from the original sheet sensor 37, it is determined whether there exists a next original sheet GS (R15). When there is a next original sheet GS to be scanned (R15: YES), the process returns to R10. When there is not a next original sheet GS (R15: NO), the scanning main process is terminated.

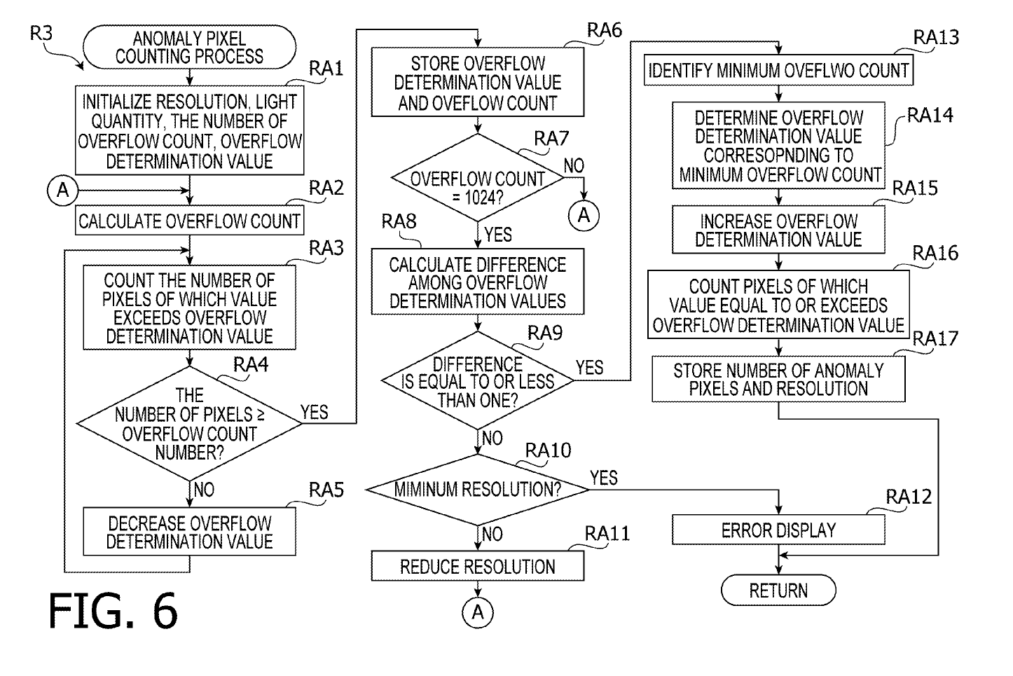

When anomaly pixel counting process illustrated in FIG. 6 is started, firstly, various pieces of data (e.g., the resolution, the light quantity, an overflow count, and an overflow determination value) are initialized. For example, the resolution may be set to the largest resolution 1200 dpi (dots per inch), and the light quantity of the light source 30 may be set in accordance with the electrical current value and the illuminating period stored in the flash PROM 43. Further, the overflow count is set to one, and the overflow determination value may be set to the largest gradation value (e.g., “1023” for 10-bit data). For example, when the image scanning apparatus is about to be shipped, the electrical current value and the illuminating period of the light source 30 are set such that, when a whit reference original sheet GS is illuminated by the light source 30, the AFE 45 outputs the gradation data having the largest gradation value (i.e., “1023” when the gradation data is 10-bit data), and the determined electrical current value and the illuminating period are stored in the flash PROM 43.

In RA2, the overflow count is calculated. That is, by multiplying overflow count previously set by a coefficient four, the next overflow count is calculated. When this step is firstly executed, since the previously set overflow count has an initialized value of one, and the next overflow count is four.

In RA3, the number of pixels each outputs the value equal to or greater than the overflow determining number. That is, in RA3, the number of pixels for each of which the AFE 45 outputs the gradation data having a value equal to or greater than the overflow determination value is counted when the gray reference plate 34 is illuminated by the light source 30 with the initialized light quantity, and the light receiving unit 31 receives the light at the initialized resolution of 1200 dpi.

In RA4, it is determined whether the number of pixels counted in RA3 is equal to or greater than the overflow count. When the number of pixels is not equal to or greater than the overflow count (RA4: NO), the process proceeds to RA5. When the number of pixels is equal to or greater than the overflow count (RA4: YES), the process proceeds to RA6.

When the number of pixels is less than the overflow count (RA4: NO), the overflow determination value is decreased by a predetermined value (RA5). The predetermined value has been preliminarily determined so as to detect a relatively large fluctuation of the gradation data due to the dust or the like adhered onto the gray reference plate 34. According to the illustrative embodiment, the predetermined value is set one. At this stage, the overflow determination value is change to a value which is a value decreased from the initial gradation value “1023” by the predetermined value. After execution of RA5, the process returns to RA3.

When the number of pixels reaches the overflow count, overflow determination value is stored in the RAM 42 in association with the overflow count (RA6). For example, assuming that the overflow count is four, and the overflow determination value is “1018”, and when fourth pixel of which the output of the AFE 45 is equal to or greater than “1018” is counted, thereby the number of the counted pixels reaching four, step RA6 is executed and the overflow determination value “1018” is stored, in association with the overflow count “4”, in the RAM 42.

In RA7, it is determined whether the overflow count is “1024”. According to the illustrative embodiment, the number “1024” is the maximum number of the overflow count. When the overflow count is not the maximum value of “1024” (RA7: NO), the process proceeds to RA2. When the overflow count is “1024” (RA7: YES), the process proceeds to RA8. When the process returns to RA2, by multiplying the previous overflow count (i.e., “4”) by the coefficient four (4), the next overflow count “16” is calculated.

When the overflow count is a number “1024”, a difference of the overflow determination values is calculated in RA8. For example, in RA6, assuming that pairs of the overflow determination value and the overflow count are (“1008”, “16”), (“1007”, “64”), (“1006”, “256”) and (“1006”, “1024”), the differences of the overflow determination values of each neighboring pairs. In the above case, the differences are “10”, “1”, “1” and “0” for the overflow counts “4”, “16”, “64” and “256”, respectively.

In RA9, it is determined whether there is a difference which is equal to or less than one. When all the differences are greater than one (RA9: NO), the process proceeds to RA10. When at least one of the differences is equal to or less than one (RA9: YES), the process proceeds to RA13.

When all the differences are greater than one, it is determined that the resolution is the minimum resolution (RA10). According to the illustrative embodiment, the minimum resolution is 300 dpi. When the resolution is the minimum resolution (RA10: NO), the process proceeds to RA11. When the resolution is the minimum resolution (RA10: YES), the process proceeds to RA12.

When the resolution is not the minimum resolution, the resolution is decreased (RA11), and the process returns to RA2. When the resolution is the minimum resolution, an error message is displayed on the display unit 6 (RA12), and the anomaly pixel calculation process is terminated.

At least one of the differences is equal to or less than one, the minimum overflow count is identified (RA13). That is, when the differences are “10”, “1”, “1” and “0” for the overflow counts “4”, “16”, “64” and “256”, respectively, the overflow count “16” is specified as the minimum overflow count.

In RA14, the overflow determination value corresponding to the minimum overflow count is set. For example, when the minimum overflow count is “16”, the overflow determination value “1008” is set as the one corresponding to the minimum overflow count.

In RA15, the overflow determination value as set is increased by the predetermined amount. According to the illustrative embodiment, the predetermined amount is set to “1” which is the minimum unit of the gradation value. For example, when the set overflow determination value is “1008”, the overflow determination value is increased by the predetermined amount (i.e., “1”) and set to “1009”. In order to eliminate the effects of the anomaly pixels for the white-referenced data having as high gradation as possible, the overflow determination value is increased by the minimum unit (i.e., the predetermined value “1”) in RA15.

In RA16, the number of the pixels which is equal to or greater than the overflow determination number is counted as in RA3. That is, the light source 30 illuminates the gray reference plate 34 in accordance with the initialized light quantity and the light receiving unit 31 receives the light in accordance with the initialized resolution or the resolution set in RA11. Then, the number of pixels for which the gradation value of the gradation data output by the AFE 45 are equal to or greater than the overflow determination value set in RA15 is counted.

In RA17, the number of anomaly pixels and the resolution are stored. That is, the number of pixels counted in RA16 is set as the number of anomaly pixels. It is noted that the thus set number of the anomaly pixels is the number of anomaly pixels when the light receiving unit 31 receives the light in accordance with the resolution initialized in FA1 or the resolution decreased in RA11. As above, the number of anomaly pixels and the resolution when the number of namely pixels are set are stored in the RAM 42. After execution of RA17, the anomaly pixel number counting process is terminated.

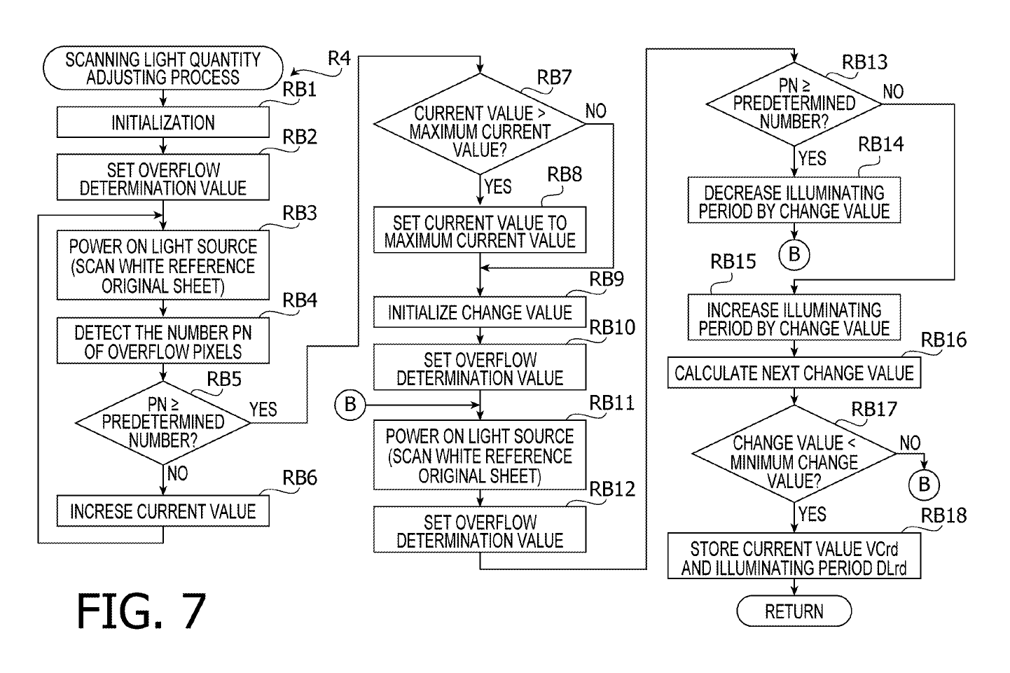

When the scanning light quantity adjustment process shown in FIG. 7 is started, various pieces of data are initialized (RB1). For example, the illuminating start time, the illuminating end time, and the electrical current value are initialized. It is noted that the illumination end time is set to the latest time and the electric current value is set to the smallest value so that the illuminating period by the light source 30 becomes longest.

In RB2, the overflow determination value is set. That is, the overflow determination value is set to the maximum value Dggmax of the gray-reference gray data Dgg stored in the flash PROM 43. At a shipping stage, the electrical current value and the illuminating period of the light source 30 are preliminarily set so that the AFE 45 outputs the largest gradation value, for example, “1023” if the gradation data is the 10-bit data, when the white reference original sheet GS is illuminated by the light source 30. Then, in a state where the light source 30 is powered on in accordance with the preliminarily set electrical current value and the illuminating period, the maximum gradation value Dggmax is detected from among the gradation values of gray-referenced gray data Dgg, which is the gray gradation data output by the AFE 45 for the pixels of one line. The detected maximum value Dggmax is stored in the flash PROM 43.

In RB3, the light source 30 is powered on in accordance with the initialized illumination start time, the initialized illumination end time and the initialized electrical current value. As the light source 30 is powered on and illuminates the gray reference plate 34, the AFE 45 output the gradation data for each pixel in accordance with the analog signal transmitted from the light receiving unit 31.

In RB4, the number PN of the overflow pixels is detected. That is, in RB4, by comparing the gradation data output by the AFE for each of the pixels of one line with the overflow determination value set in RB2, the number of the pixels each having the gradation data of which value is equal to or greater than the overflow determination value is detected of the one line.

In RB5, it is determined whether the number PN of the anomaly pixels is a anomaly pixel reference number. The anomaly pixel reference number is the number of stored in the RAM 42 in RA17. When the number PN is less than the anomaly pixel reference number (RB5: NO), the process proceeds to RB6. When the number PN is equal to or greater than the anomaly pixel reference number (RB5: YES), the process proceeds to RB7.

When the number PN of the anomaly pixels is less than the anomaly pixel reference number (RB5: NO), the electrical current is increased (RB6), and the process returns to RB3. In RB3, the light source 30 is powered on in accordance with the initialized illumination start time, the initialized illumination end time and the electrical current value increased in RB6.

When the number PN of the anomaly pixels has reached the anomaly pixel reference number, it is determined whether the electrical current value increased in RB6 is greater than the maximum electrical current value (RB7). When the increased electrical current value is greater than the maximum electrical current value (RB7: YES), the electrical current value is set to the maximum electrical current value (RB8), and the process proceeds to RB9. When the increased electrical current value is equal to or less than the maximum electrical current value (RB7: NO), the process proceeds to RB9.

In RB9, a change value is initialized. The change value is a minimum unit value for changing the illuminating period, and preliminarily set. In RB10, the overflow determination value is set to the maximum value Dggmax stored in the flash PROM 43 as in RB2.

In RB11, the light source 30 is driven in accordance with the initialized illumination start time, the initialized illumination end time, the electrical current value increased in RB6 or the maximum electrical current value set in RB8. The light source 30 illuminates the gray reference plate 34, and the AFE 45 outputs the gradation data of each pixel in accordance with the analog signal received from the light receiving unit 31.

In RB12, the number PN of the overflow pixels is detected. That is, in RB12, the gradation data output by the AFE 45 is compared with the overflow determination value set in RB10, and the number of the pixels of which the gradation data values are greater than the overflow determination value is detected.

In RB13, it is determined whether the number PN of the overflow pixels is equal to or greater than the anomaly pixel reference number. It is note that the anomaly pixel reference number is the number stored in the RAM 42 in RA17. When the number PN of the overflow pixels is equal to or greater than the anomaly pixel reference number (RB13: YES), the process proceeds to RB14. When the number PN of the overflow pixels is less than the anomaly pixel reference number (RB13: NO), the process proceeds to RB15.

When the number PN of the overflow pixels is equal to or greater than the anomaly pixel reference number, the illuminating period is shortened by the change value (RB14). That is, the illuminating period is reduced such that the illumination end time is shortened by an amount of the change value which is initialized in RB9. After execution of RB14, the process returns to RB11. In RB11, the light source 30 is driven in accordance with the illuminating period that has been reduced in RB14, and the electrical current value increased in RB6 or the maximum electrical current value set in RB8.

When the number PN of the anomaly pixels is less than the anomaly pixel reference number, the illuminating period is increased by the change value (RB15), and then the next change value is calculated (RB16). That is, half the previous change value is calculated as a next change value.

In RB17, it is determined whether the change value calculated in RB16 is less than a minimum change value. When the change value is equal to or greater than the minimum change value (RB 17: NO), the process proceeds to RB11. When the change value is less than the minimum change value (RB17: YES), the process proceeds to RB18.

The electrical current value and the illuminating period are stored in the flash PROM 43 in RB18. That is, the electrical current value increased in RB6 or the maximum electrical current value set in RB8 is stored, as the scanning electrical current value VCrd, in the flash PROM 43, and the increased illuminating period increased in RB15, namely, the illumination start time and the illumination end time, is stored, as the scanning illuminating period LDrd, in the flash PROM 43. After execution of RB18, the scanning light quantity adjusting process R4 is terminated.

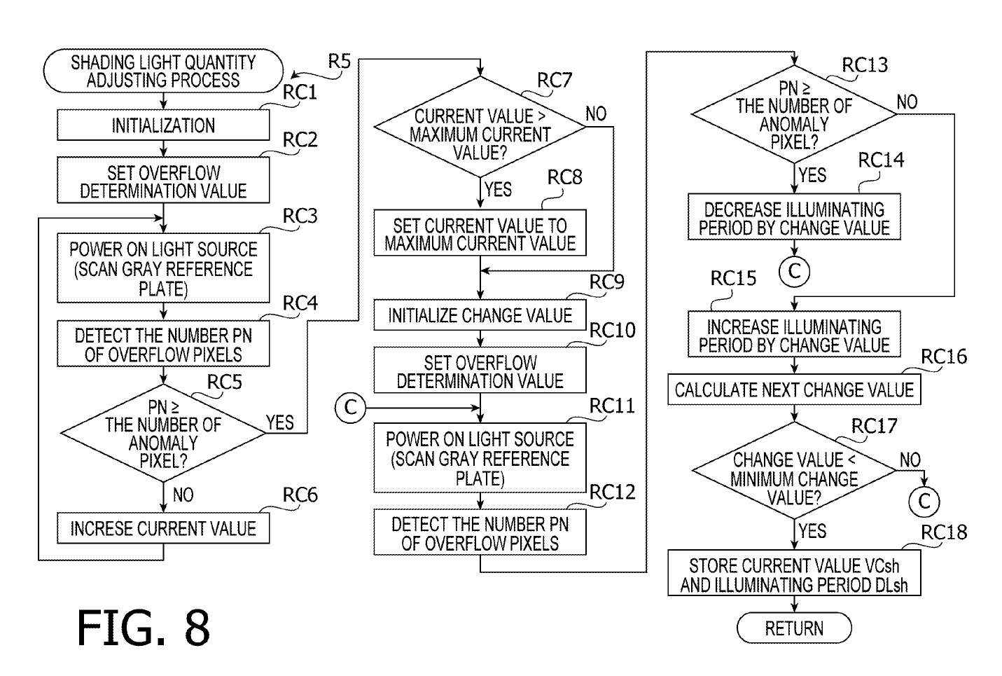

Next, the shading light quantity adjusting process will be described with reference to FIG. 8. When the shading light quantity adjusting process is started, steps RC1-RC18, which are similar to steps RB1-RB18 of the scanning light quantity adjusting process, are executed. Since the steps are substantially similar, among the steps shown in FIG. 8, ones different from the steps of the scanning light quantity adjusting process will be described.

In RC1, data is initialized. For example, the illuminating period, the illumination start/end times, and the electrical current value for the light source 30 are initialized. At this stage, the illumination end time is set such that the illuminating period of the light source 30 has a maximum period, and the electrical current is set to the minimum current value.

In RC3, the overflow determination value is set. That is, the overflow determination value is set to the gradation data having the highest gradation value stored in the flash PROM 43. For example, when the gradation data is 10-bit data, “1023” is set as the overflow determination value in RC3.

Steps RC3-RC8 are executed similarly to steps RB3-RB8 described above, and the electrical current value for the shading is determined.

In RC9, the change value is initialized. The change value is the minimum unit value for changing the illuminating period, and preliminarily determined Further, the overflow determination value is set to the gradation data of the highest gradation value stored in the flash PROM 43, as in RC2.

Steps RC11-RC17 are executed similarly to steps RB11-RB17, and the illuminating period for shading is determined.

In RC18, the electrical current value and the illuminating period are stored in the flash PROM 43. That is, the electrical current value increased in RC6 or set to the maximum electrical current value in RC8 is stored in the flash PROM 43 as the electrical current value VCsh for the shading, and the illuminating period increased in RC15 (i.e., the illumination start/end times) is stored, as the illuminating period DLsh for the shading, in the flash PROM 43. After execution of RC18, the shading light quantity adjusting process is terminated.

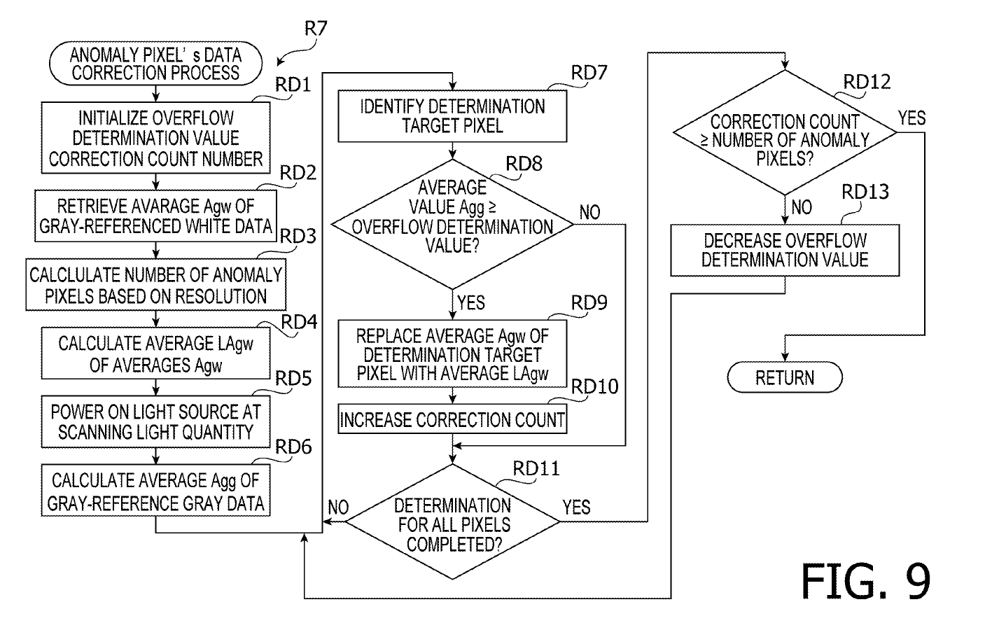

When an anomaly pixel's data correction process shown in FIG. 9 is started, the overflow determination value and a correction count number are initialized in RD1. That is, the overflow determination process is set to the maximum value Dggmax of the gray-referenced gray data Dgg which is stored in the flash PROM 43, and the correction count is set to zero.

In RD2, an average value Ag2 of the gray-reference white data is retrieved for each pixel. That is, the average value Agw of the gray-referenced white data Dgw for each of the pixels of one line, which is stored in the RAM 42 in R6 is retrieved.

In RD3, in accordance with the resolution, the number of anomaly pixels are calculated. When the user operates the operation unit 5 and set a desired resolution for scanning the original sheet GS, the set resolution (i.e., the desired resolution) may be different from the resolution stored in the RAM 42 in RA17. Therefore, in RD3, by multiplying the anomaly pixel reference number by the ratio of the desired resolution to the stored resolution, a new anomaly pixel reference number is calculated in accordance with the resolution. For example, when the desired resolution and the stored resolution are 600 dpi and 300 dip, respectively, and the anomaly pixel reference number for the resolution of 300 dpi is “15”, the new anomaly pixel reference number is calculated as indicated below.

15×600/300=30

In RD4, an average value LAgw of the average values Agw is calculated. That is, the average values Agw for respective pixels retrieved in RD2 are averaged for one line to calculate the average value LAgw.

In RD5, the light source 30 is driven in accordance with the scanning light quantity. That is, the light source 30 is driven in accordance with the electrical current value VCrd and the illuminating period DLrd which are stored in the flash PROM 43 at RB 18. By the light source 30, the gray reference plate 34 is illuminated, and the AFE 45 outputs the gray gradation data, or the gray-referenced gray data Dgg in accordance with the analog signal transmitted from the light receiving unit 31.

In RD6, the average value Agg of the gray-referenced gray data is calculated. That is, the gray-referenced gray data Dgg output by the AFE 45 is repeatedly output are retrieved by a predetermined times for one line . Then, the average value Agg of the gray-referenced gray data Dgg is calculated for one line, and stored in the RAM 42. It is noted that the average value Agg is the value averaging the gradation values of the gray-referenced gray data Dgg of respective pixels of one line.

In RD7, a target pixel is identified. That is, one pixel subject to determination in next step RD8 is identified as the target pixel. According to the illustrative embodiment, at every execution of RD7, each pixel is sequentially identified from a start to an end of one line.

In RD8, it is determined whether the average value Agg is equal to or greater than the overflow determination value. That is, it is determined whether each of the average values Agg for respective pixels, which are stored in the RAM 42 in RD6, is equal to or greater than the maximum value Dggmx of the gray-reference gray data Dgg. When the average value Agg is equal to or greater than the maximum value Dggmax (RD: YES), the process proceeds to RD9. When the average value Agg is less than the maximum value Dggmax (RD8: NO), the process proceeds to RD11.

In RD9, the average value Agw of the target pixel is replaced with the average value LAgw. That is, the pixel of which average value Agw is equal to or greater than the maximum value Dggmax, the pixel is the anomaly pixel. In such a case, the average value Agw of the anomaly pixel is corrected as replaced with the average value LAgw. The average values Agw, including the replaced average value Agw, are stored in the RAM 42.

In RD10, a correction count is incremented by one. The correction count represents the number of the anomaly pixels which are determined to be the anomaly pixels in RD8.

In RD11, determination is made for all the pixels. When determination has not been made for all the pixels (RD11: NO), the process returns to RD7. When determination has been made for all the pixels (RD11: YES), the process proceeds to RD12.

When determination has been made for all the pixels, it is further determined whether the correction count is equal to or greater than the anomaly pixel reference number (RD12). That is, it is determined whether the correction count incremented in RD10 is equal to or greater than the anomaly pixel reference number calculated in RD3. When the correction count is equal to or greater than the anomaly pixel reference number (RD12: YES), the anomaly pixel correction process is terminated. When the correction count is less than the anomaly pixels (RD12: NO), the process proceeds to RD13.

When the correction count is less than the anomaly pixel reference number, the overflow determination number is decremented by one (RD13). That is, the maximum value Dggmax, which is the current overflow determination value is decremented by one. After execution of RD13, the process returns to RD7. In the following process, each of the average value Agw for the respective pixels is compared with the overflow determination value which is decremented by one in RD13.

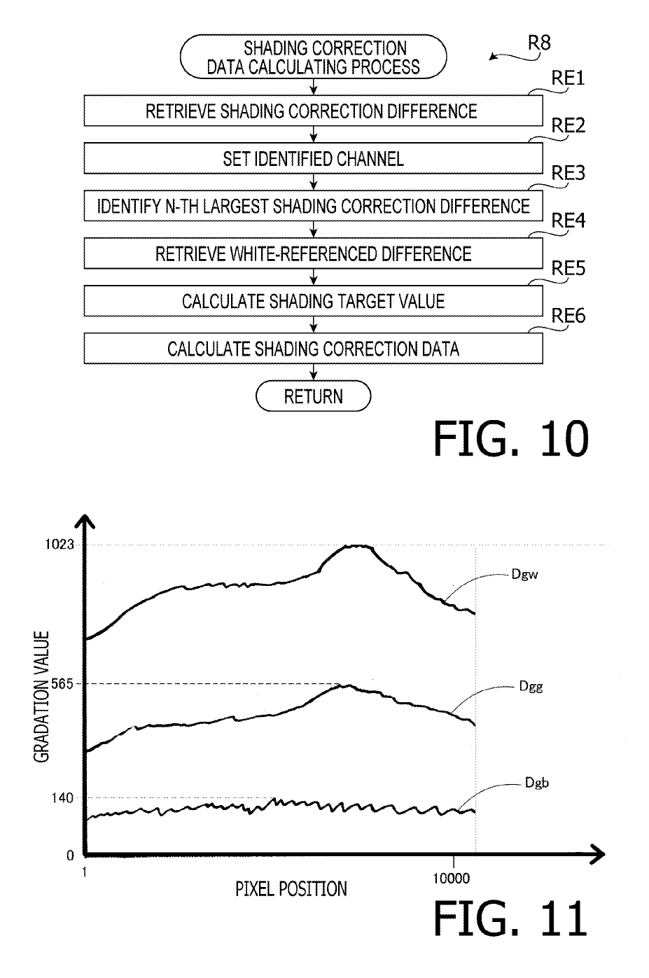

When a shading correction data calculating process shown in FIG. 10 is started, the gray-reference difference SAg for each pixel is calculated in RE1. That is, for each pixel in one line, the average value Agw stored in the RAM 42 at RD9 is retrieved, and the average value Agb of the gray-referenced black data Dgb stored in the RAM 42 at R6 is retrieved. Then, a gray-reference difference SAg is calculated by subtracting the average value Agb from the average value Agw for each pixel of one line.

Among the gray-referenced differences SAg for respective pixels of one line, a gray-referenced difference which is an N-th one from the maximum gray-referenced difference is identified as a gray-referenced difference SAgmax (RE2). The number N is determined based on the resolution. According to the illustrative embodiment, the number N is set to the anomaly pixel reference number corresponding to the resolution being set for scanning of the original sheet GS since the number N is stored in the RAM 42, in RA17, in association with the resolution. As a result, in RE2, the maxim gray-referenced difference SAgmax is identified with eliminating the anomaly pixels in one line.

For each pixel of one line, the white-reference difference SAw is retrieved, and the maximum white-referenced difference SAwmax among the white-referenced differences SAw for respective pixels of one line is detected (RE3). At the shipping stage, as the white-referenced difference SAw, a value calculated by subtracting an average value Awb of white-referenced black data Dwb from the average value Aww of the white-referenced white data Dww is preliminarily stored in the flash PROM 43 for each pixel. In RE3, the white-referenced differences SAw are retrieved from the flash PROM 43. Then, among the retrieved white-reference differences SAw, the maximum value SAwmax of the white-referenced differences SAw is detected.

In RE4, a shading target value Atw is calculated. That is, the shading target value Atw is calculated by multiplying the maximum gradation value by the difference ratio SAgmax1/SAwmax of the shading correction difference SAgmax1 identified in RE2 and the maximum value SAwmax, as indicated below.

Shading target value Atw=Maximum gradation value X (SAgmax/SAwmax) According to the illustrative embodiment, the maximum gradation value is represented by the 10-bit data and is “1023”, and the shading target value Atw is calculated as 10-bit data.

In RES, for each pixel, the shading correction data is calculated. That is, by dividing the 10-bit maximum gradation value “1023” by the difference calculated by subtracting the average value Agb of the gray-referenced black data Dgb from the shading target value Atw, the shading correction data is calculated as follows:

Shading correction data=1023/(Atw−Agb)

According to the illustrative embodiment, in R3, the number of pixels of which gradation values output by the AFE 45, when the light source 30 illuminates the gray reference plate 34, are equal to or greater than the overflow determination value, which is changeable counted. The counted number of pixels is equal to or greater than an overflow count number, which is set stepwise, the overflow determination value and the overflow count are stored in association with each other. Then, among the overflow counts of which the overflow determination values are equal to or less than one, the minimum overflow count is identified. Based on the identified overflow count, the anomaly pixel reference number is determined As a result, the number of anomaly pixels of which gradation data values largely fluctuate due to dust adhered onto the gray reference plate 34 can be identified relatively easily without comparing, for each pixel of one line, the gradation data thereof with that of the neighboring pixels.

Further, in the anomaly pixel's data correction process, an anomaly pixel is identified based on the average value Agg of the gradation data value of a pixel is equal to or greater than the maximum value Dggmax which is the overflow determining value, and the average value Agw of the gray-referenced white data Dgw is replaced with the average value LAgw for the anomaly pixels. Accordingly, when the light source 30 illuminates the gray reference plate 34, the average values Agw of the gray-referenced white data from which the effects of the dust adhered on the gray reference plate 34 is removed can be generated. Based on the gray-referenced differences SAg calculated from the average values Agw, appropriate shading correction data can be calculated.

According to the illustrative embodiment, in the scanning light quantity adjusting process, the electrical current value and the illuminating period of the light source which are set when the number PN of the overflow pixels is equal to or greater than the anomaly pixel reference number are set as the scanning electrical current value VCrd and the scanning illuminating period DLrd, respectively. As a result, the scanning electrical current value and the and illuminating period can be set with eliminating effects of the anomaly pixels due to dust or the like.

Further, in the shading light quantity adjusting process, the electrical current value and the illuminating period which are set when the overflow pixel number PN is equal to or greater than the anomaly pixel reference number which is determined in R3 as the shading electrical current VCsh and the shading illuminating period DLsh, respectively, with eliminating effects of the anomaly pixels due to dust or the like.

According to the illustrative embodiment, when all the differences of two overflow determination values become equal to or less than one, that is, when the resolution is too high and the fluctuations of the gradation data values of respective pixels is too minute, the resolution value is automatically decreased in RA11. As a result, the anomaly pixels can be identified at an appropriate resolution.

According to the illustrative embodiment, the resolution is decreased in RA10, from its highest value, which is a resolution initialized in RA1 Further, in RA9, when one of the differences of two overflow determination values is determined firstly to be equal to or less than one, the anomaly pixel determining process is executed in steps after RA13. As a result, the number of the anomaly pixels can be determined correctly based on the gradation data of which resolution can be maintained as high as possible.

According to the illustrative embodiment, when the user sets a desired resolution for scanning the original sheet GS, the number of anomaly pixels are newly calculated in accordance with the desired resolution in R7. As a result, even if the user-desired resolution is set, it is ensured that the average values Agw of the gray-referenced white data Dgw corresponding to the anomaly pixels are corrected.

The image scanning apparatus 1 and the gray reference plate 34 are examples of image scanning apparatus and gray reference member set forth in claims, respectively. Further, the scanning unit 24, the light source 30 and the photoelectric conversion elements 33 of the light receiving unit 31 are examples of scanning unit, light source and photoelectric conversion elements set forth in the claims, respectively. The AFE 34 is an example of a signal conversion unit set forth in the claims.

The operation unit 5 is an example of a unit allowing a user to set the scanning resolution in the main scanning direction.

Steps RA1, RA2 and RA13 executed by the CPU 40 realize an example of an operation of the controller to first to N-th target numbers of pixels set forth in the claims, where N being more than two. Steps RA1, RA5 and RA15 executed by the CPU 40 realize an example of an operation of the controller to changeably set a reference gradation value set forth in the claims.

A step RA6 executed by the CPU 40 realizes an example of an operation of the controller to store, in the storage, a specific reference gradation value in association with the target number of pixels. Steps RA8, RA9, RA10, RA11 and RA13 executed by the CPU 40 realize an example of an operation of the controller to determine a correction target number set forth in the claims. Steps RA14-RA17 executed by the CPU 40 realize an example of an operation of the controller to determine an anomaly pixel number. A step RD9 executed by the CPU 40 realizes an example of an operation of the controller to correct the gradation values of the anomaly pixels set forth in the claims.

A step R5 executed by the CPU 40 realizes an example of an operation of the controller, set forth in the claims, to set the light quantity of the light source when the gray reference member is illuminated to obtain the gradation value of the white signal for shading correction to the light quantity when the number of pixels providing gradation values equal to or greater than a predetermined gradation value.

Steps RD8 and RD10 executed by the CPU 40 realize an example of an operation of the controller, set forth in the claims, to count the number of pixels of which gradation values of the gray signal are equal to or greater than the specific gradation value.

A step RD13 executed by the CPU 40 realizes an example of an operation of the controller, set forth in the claims, to modify the specific gradation value to set a new specific gradation value. A step RD4 executed by the CPU 40 realizes an example of an operation of the controller, set forth in the claims, to calculate an average value of gradation values of the white signal output by the signal conversion unit.

The overflow count and the overflow determination number are examples of a target number of pixels and a target reference gradation value, respectively, set forth in the claims.

The gray-referenced white data Dgw is an example of a white signal set forth in the claims, and the average value Agw of the gradation values of the gray-reference white data Dgw for respective pixels is an example of the gradation value set forth in the claims. Further, an overflow determination value increased by a predetermined amount in RA15 is an example of a base gradation value set forth in the claims.

It is noted that the above-described embodiment is an illustrative embodiment and the scope the disclosures should not be limited to the configuration of the illustrative embodiment. As described below, the illustrative embodiment can be modified in various ways without departing from the scope of the disclosures.

The image scanning apparatus 1 according to the illustrative embodiment could be applied to an MFP (multi-function peripheral) having a printer unit.

According to the illustrative embodiment, the image scanning apparatus has only one scanning unit 24 and one gray reference plate 34. The configuration could be modified, to scan both sides of the original sheet GS, such that two scanning units and tow gray reference plates may be provided to the image scanning apparatus.

According to the illustrative embodiment, the scanning main process shown in FIG. 5 is executed by the CPU 40. It is noted that the scope of the disclosures need not be limited to the configuration of the illustrative embodiment. For example, part of steps of R3-R8 of the scanning main process may be executed by the image processing unit 46. Alternatively, the above portions may be executed by an external device independent from the image scanning apparatus 1, for example, by a PC (personal computer).

According to the illustrative embodiment, the highest resolution set as an initial setting is reduced in RA10. Aspects of the disclosures need not be limited to such a configuration. For example, the number of anomaly pixels may be determined based on a specific resolution which is typically or normally used for scanning, or the lowest resolution available to the image scanning apparatus 1.

According to the illustrative embodiment, the average value Agw of the gray-referenced white data Dgw of the anomaly pixels are replaced with the average value LAgw. Aspects of the disclosures need not be limited to such a configuration. For example, instead of the average value LAgw, a value obtained by multiplying the average value Agw by an average of difference ratios SAg/SAw may be used. Alternatively, instead of the average value LAgw, the average values Agw of the pixels neighboring the anomaly pixels may be used.

It is noted that the difference SAg is calculated by subtracting the average value Agb of the gray-referenced black data Dgb from the average value Agw of the gray-referenced white data Dgw, and the difference SAw is calculated by subtracting the average value Awb of the white-referenced black data Dwb from the average value Aww of the white-referenced white data Dww.

The white-referenced white data Dww is gradation data of white color the AFE 45 outputs in accordance with the analog signal received from the light receiving unit 31, when the light source 30 illuminates the white reference original sheet GS in accordance with the electrical current value VCrd and the illuminating period DLrd which are set so that gradation data of the highest gradation value is output by the AFE 45.

The average value Aww is an average of a plurality of pieces of white-referenced white data Dww which are obtained by a plurality of times for each of the pixels of one line. The white-referenced black data Dwb is the gradation data of black color which is output by the AFE 45 based on the light receiving unit 31 when the light source 30 is turned off. The average value Awb is an average value of a plurality of pieces of the white-referenced black data obtained by a plurality of times for each of the pixels of one line.

According to the illustrative embodiment, the average value Agw of the gradation values of the gray-referenced white data Dgw and the average value Agb of the gray-referenced black data for each pixel are calculated in R6.

In RB1, the average Agw of the gray-referenced white data Dgw and the average value Agb of the gray-referenced black data for each of pixels of one line are obtained in RB1. It is noted that the values retrieved in this step need not be limited to the average values.

For example, instead of the average values Agw and Agb, the gradation values of the gray-referenced white data Dgw and the gray-referenced black data Dgb may be used.

According to the illustrative embodiment, the number of pixels of which the gradation values of the gradation data output by the AFE 45 for respective pixels of one line are equal to or greater than the overflow determination value are counted in RA3 and RA16. Further, in RB4 and RC4, the gradation values of the gradation data output by the AFE 45 for respective pixels of one line are compared with the overflow determination value. The above configuration may be modified such that, instead of the gradation data the AFE 45 outputs for one line of pixels corresponding to the channels CH1-CH6, only one specific channel is identified such that the photoelectric conversion elements 33 in the specific channel outputs the analog signal corresponding to the gradation data having the brightest gradation value, and the analog signal corresponding to the specific channel may be used.

Further, among one line of pixels, anomaly pixels are identified in RD8, and among the gray-referenced differences SAg for the respective pixels of one line, the N-th greatest gray-referenced difference SAgmax is identified in RE2. However, instead of the one line of pixels, the pixels may be limited to those corresponding to the specific channel.

According to illustrative embodiment, from among the pixels of which the gradation values largely fluctuate, anomaly pixels are identified by the number represented by the anomaly pixel reference number. Aspects of the disclosures need not be limited to such a configuration.

For example, the CPU may be configured to execute a process of determining whether the gradation value of white data output by the AFE for each of the pixels of one line is equal to or greater than a reference gradation value that corresponds to the overflow determination value set in RA15 when the light source illuminates the gray reference part, the process including a counting process to count the number of the pixels of which the gradation value of the white data is equal to or greater than the reference gradation value, the process including a modifying process to reduce the reference gradation value when the number of the counted pixels is less than the anomaly pixel reference number and count the number, the counting process determining whether the gradation value of the white data output by the AFE is equal to or greater than a new reference gradation value which is set by the modifying process, and count the number of pixels of which the gradation values of the white data are equal to or greater than the new reference gradation value.

According to the illustrative embodiment, in RC2 and RC10, the overflow determination value is set to the gradation data of the highest gradation value which is stored in the flash PROM 43. This configuration may be modified such that the overflow determination value may be set to a predetermined gradation data smaller than “1023”.

For example, the maximum value of the gray-reference white data, of the gradation data output by the AFE 45 for respective pixels of one line when the light source 30 illuminates the gray reference plate 34 with the maximum electrical current value and the longest illumination period, which are determined based on the configurations of the light source 30 and its driving circuit may be used as the overflow determination value. In such a case, the maximum value of the gray-reference white data is the data for the pixels of one line other that the anomaly pixels.

What is claimed is:

1. An image scanning apparatus, comprising:
a gray reference member arranged in a conveying path in which an original sheet is to be conveyed, the gray reference member having a reflection coefficient smaller than that of a white color;
a scanning unit configured to scan an image on the original sheet on a line basis, the scanning unit including a light source configured to illuminate the original sheet when passing the gray reference member and a plurality of photoelectric conversion elements aligned in a scanning direction which is a transverse direction of the conveying path;
a signal conversion unit configured to convert analog signals from the plurality of photoelectric conversion elements to digital signals, respectively;
a storage; and
a controller,
the controller being configured to:
set first to N-th target numbers of pixels, each target number representing the number of a plurality of pixels, N being more than two;
changeably set a reference gradation value which represents a value of a white signal output by the signal conversion unit for each pixel when the light source illuminates the gray reference member, between a highest gradation value and a smaller gradation value which is smaller than the highest gradation value;
store, in the storage, a specific reference gradation value in association with the target number of pixels when the number of pixels having gradation values equal to or greater than the specific reference gradation value is a specific target number of pixels;
determine a correction target number which is a minimum target number of pixels from among a plurality of target numbers of pixels respectively providing differences, which is less than a predetermined value, between the reference gradation value stored in association with an M-th target number among the first to N-th target numbers and the reference gradation stored in association with an (M+1)-th target number;
determine an anomaly pixel number which is the number of anomaly pixels having gradation values which are equal to or greater than a base gradation value, the base gradation value being determined based on the reference gradation value stored in the storage in association with the correction target number of pixels from among the gradation values of the with signal output by the signal conversion unit for respective pixels when the light source illuminates the gray reference member; and
correct the gradation values of the anomaly pixels, the number of the anomaly pixels of which gradation values are to be corrected being the anomaly pixel number.

2. The image scanning apparatus according to claim 1, wherein:
when the light source illuminates the gray reference member and the scanning unit performs a scanning operation at a first resolution, the controller sets a second resolution which is lower than the first resolution in a main scanning direction which is orthogonal to a conveying direction of the original sheet when there is no target number of pixels providing the difference equal to or smaller than the predetermined value among the first to N-th target numbers of pixels; and
when the light source illuminates the gray reference member and the scanning unit performs the scanning operation at the second resolution, the controller detects a plurality of target numbers of pixels providing the difference equal to or smaller than the predetermined value, and determines a smallest one of the detected target number of pixels.

3. The image scanning apparatus according to claim 2, wherein:
the controller is configured to set a scanning resolution in the main scanning direction at which the scanning unit performs the scanning operation; and
when the scanning resolution is different from the second resolution, the controller modifies the number of anomaly pixels in accordance with a ratio of the scanning resolution to the second resolution.

4. The image scanning apparatus according to claim 1, wherein the controller stores the number of the anomaly pixels and the resolution of the white signal which is output, by the signal conversion unit, when the number of the anomaly pixels is determined in association with each other.

5. The image scanning apparatus according to claim 4, wherein the controller is further configure to set the light quantity of the light source when the gray reference member is illuminated to obtain the gradation value of the white signal for shading correction to the light quantity when the number of pixels providing gradation values equal to or greater than a predetermined gradation value.

6. The image scanning apparatus according to claim 1, wherein the reference gradation value is determined by adding a predetermined value to the reference gradation value which is stored in the storage in association with the correction target number of pixels

7. The image scanning apparatus according to claim 1,
wherein the controller is further configured to:
determine whether or not the gradation value of the gray signal output by the signal conversion unit for each of pixels of one line when the light source illuminates the gray reference member is equal to or greater than specific gradation value;
count the number of pixels, from among all the pixels in one line, of which gradation values of the gray signal are equal to or greater than the specific gradation value;
modify the specific gradation value to set a new specific gradation value by reducing the specific gradation value when the counted number of pixels is less than the number of the anomaly pixel reference value;
determine whether the gradation values of the gray signal output by the signal conversion unit is equal to or greater than the new specific gradation value; and
count the number of pixels, from among all the pixels in one line, of which gradation values of the gray signal are equal to or greater than the new specific gradation value, and
wherein the specific gradation value before modified is a greatest one of the gradation values of the gray signal output by the signal conversion unit when the light source illuminates the gray reference member in accordance with the first light quantity, the first light quantity being defined such that the white signal having the first gradation value is output by the signal conversion unit when the light source illuminates the white reference value in accordance with the first light quantity.

8. The image scanning apparatus according to claim 1, wherein the controller is further configured to:
calculate an average value of gradation values of the white signal output by the signal conversion unit for respective pixels of one line when the light source illuminates the gray reference member; and
correct the gradation values of the determined number of anomaly pixels by replacing the gradation values of the anomaly pixels with the average value of the gradation values of the white signal.
